(19) United States
(12) Patent Application Publication
(10) Pub. No.: US 2026/0047976 A1
(43) Pub. Date: Feb. 19, 2026

(54) Unweighting System for Reducing Gravity Using a Camera

(71) Applicant: TECNOBODY S.P.A., Dalmine (IT)

(72) Inventors: Stefano MARCANDELLI, Stezzano (IT); Alessandro CARMINATI, Stezzano (IT); Ivan BELOTTI, Verdellino (IT); Cecilia GATTI, Bergamo (IT); Marco GIDONI, Stezzano (IT); Rudi PIRANI, München (DE)

(21) Appl. No.: 19/126,521

(22) PCT Filed: Nov. 6, 2023
(86) PCT No.: PCT/IB2023/061155

§ 371 Date: May 1, 2025

(30) Foreign Application Priority Data
Nov. 8, 2022 (IT) 102022000023076

(51) Int. Cl. A61H 3/00

(52) U.S. Cl. CPC A61H 3/008; A61H 2201/0173; A61H 2201/1207; A61H 2201/1652; A61H 2201/1664; A61H 2201/5007; A61H 2201/5061; A61H 2201/5071; A61H 2201/5092; A61H 2230/805

(57) ABSTRACT

According to the disclosure, an unweighting system is provided to reduce the gravity load of a subject due to the weight acting along a first Z axis, the unweighting system including a support structure, motor and subject movement system mounted on the support structure. The movement system includes a first rail and a second rail parallel to a second Y axis; a third rail parallel to a third axis perpendicular to the second Y axis, wherein the third rail extends between the first rail and the second rail and is configured to slide along the first and second rails in order to move along the second Y axis; a sliding element configured to slide along the third rail in the direction of the third X axis; a cable associated with the sliding element and driven by the motor to reduce the subject's gravity load in the direction of the first axis; a supporting element for the subject, associated with the cable. The unweighting system includes a camera configured to detect a subject's position in space.

### TECHNICAL FIELD

The present invention relates to the field of unweighting systems for reducing the gravity load of a subject, for example, medical-type unweighting systems.

### STATE OF THE ART

To date, robotics has invested several resources in the development of adjuvant technologies to the recovery of locomotion gesture in rehabilitation and re-education. This is in fact a fundamental motor activity involving muscular and neurological aspects and finding application in both health care and sports.

Over the past decade, industrial research has developed several systems to help therapists to safely re-educate patients in the gesture of orthostatism and walking.

Several types of unweighting systems are known in the state of the art, such as single-point and linear unweighting systems on treadmills, the linear ground unweighting systems (without the use of treadmills), and the systems of three-dimensional unweighting on the ground.

However, the unweighting systems known at the state of the art have several disadvantages.

Single-point and linear unweighting systems on treadmills distort the proper movement of ambulation, limit the rotation of the pelvis and trunk and the user's ability to use arms. In addition, some of these systems are also difficult to access for patients in wheelchair, who represent a category of people significantly involved in the medical rehabilitation and motor rehabilitation.

Linear ground unweighting systems allow conventional gait training: with these systems, in fact, pitch variation is natural, as is postural maintenance.

Nonetheless, one is still constrained to a linear exploration, with no possibility of spacing three-dimensionally in the surrounding environment.

In view of the limitations considered so far, unweighting systems have developed in recent years three-dimensional space on the ground to allow the user to explore a three-dimensional space.

However, these systems are sizable, expensive, even in terms of electrical consumption, and as a whole complex in installation.

Document US20070004567 describes, for example, a three-dimensional unweighting system comprising a Cartesian gantry robot. The unweighting system of the document US20070004567 has the disadvantage of necessarily having to be servo-assisted on all three axes. In fact, the user's lifting motor (and thus the mass of the motor itself and of transmissions) should always be placed above the user and, considering the high mass of the motor, without the help of servo-assistance on the other axes of motion, would be very difficult for the user to perform translations in the plane perpendicular to the direction of lifting. In addition, the system lifts the user only by means of a cable, without a special body, which, by stiffening the connection between the user and the positioning system, enables transmission of transverse forces to the positioning system itself.

In view of the problems and disadvantages presented above, it is an object of the present invention to provide an unweighting system that solves one or more of these problems.

### SUMMARY

The present invention is based on the idea of providing an unweighting system, either assisted along one axis or along three axes, additionally equipped with a camera that can monitor the interactions between the unweighting system and the subject using it.

According to one aspect of the present invention, an unweighting system is provided to reduce the gravity load of a subject due to the weight acting along a first Z axis, said unweighting system comprising a support structure, a motor and a movement system of the subject mounted on the support structure, wherein the movement system includes the following elements:
A first rail and a second rail parallel to a second Y-axis;
A third rail parallel to a third X axis perpendicular to the second Y axis, wherein the third rail extends between the first rail and the second rail and is configured to slide along the first and second rails so as to move along the second Y-axis;
A sliding element configured to slide along the third rail in the direction of the third X-axis;
A cable associated with the sliding element and driven by the motor to reduce the gravity load of the subject along said first axis Z;
A support element for the subject, associated with the cable;
wherein the first Z axis, the second Y axis and the third X axis form a Cartesian coordinate system.

The unweighting system is characterized by the fact that it comprises a markerless technology camera configured to detect a location of the subject in space.

The advantage of the unweighting system according to the present invention is that the camera makes it possible to detect the subject under investigation and its interaction in the operating space within which the subject has freedom of movement. For example, by means of the camera, it is possible to accurately detect the position of all body joints as well as their orientation.

The information gathered from this analysis is used to equip the system with various additional functions that would not be available without its use, such as the ability to identify the subject's precise position in 3D space and thus correctly and automatically positioning the harness. In addition, throughout the operation of the system, the camera can perform motion analysis and the system can provide information regarding its quality, for example, via a computer that interacts with the operator.

In addition, the presence of the camera allows the subject's state of balance to be monitored, and if the camera detects continued states of precarious balance, the system can be set up to be more responsive and allow for less wide and less fast movements. If, for example, based on the camera images, the system predicts that the subject may fall, it can take preventive action, preventing the fall. In this way, the safety functions of the system are enhanced.

Finally, according to a preferred embodiment of the present invention, the camera is combined with an unweighting system with three active axes, and the system can intervene to correct the subject's position if the subject is deviating from the optimal movement, based on the images obtained from the camera by monitoring the subject's movement in real-time and knowing the movement to be performed by the subject.

Markerless technology makes it possible to capture images of subjects without markers (markers) or sensors attached to the subjects themselves.

Markerless technology has several advantages. First, since markers do not need to be applied, image acquisition times are reduced.

In addition, markerless technology makes it possible to capture images of subjects more economically and efficiently than marker-based technology because the presence of highly trained personnel is not required to apply the markers. Any errors in the placement of the markers in turn induce errors in the detection of the positions of the user's body parts marked by the markers.

It should also be considered that, during image acquisition, the markers may move or detach from the position in which they were originally attached and that any deviations of the markers from their original positions increase the error in detecting the positions of the user's body parts marked by the markers.

In addition, analysis of the data acquired on the basis of the markers is often time-consuming and complex, requiring the presence of trained technical personnel. In contrast, markerless systems provide data in real time and do not require the presence of trained personnel to analyze the acquired data.

Finally, markerless technology systems are advantageous because they allow more precise and accurate data acquisition and analysis. In fact, different data acquisition centers may train personnel who apply markers differently, so usually the inter-center error (i.e., the error calculated from data acquired from different centers while applying the same procedure) is higher than the intra-center error (i.e., the error calculated from data acquired from the same acquisition center). Then there are different data acquisition protocols that define different types of markers and consequently calculate articular joint centers differently and at different positions, lowering the repeatability of acquisitions. In contrast, in markerless systems, the repeatability of acquisitions is ensured by using the same Skeletal Tracking algorithm that always places the markers in the same locations.

According to a further aspect of the present invention, a method is provided for determining the position of a subject with respect to the unweighting system, for example, for virtual reality simulations, wherein the method comprises the step of:
(a) Detecting a position of predefined elements of the subject, for example of a plurality of articular joints of the subject, using the markerless technology camera.

In one embodiment of the present invention, a method is provided for detecting and/or predicting the falling of the subject and activating the mode of securing the subject in the unweighting system.

In one embodiment of the present invention, a method is provided for detecting the position in 3D space of the subject in order to automatically translate the harness behind the subject following a safe path unobstructed by objects or people.

In one embodiment of the present invention, a method is provided for detecting the position of the subject in order to automatically lift the subject from a sitting position when said subject leans forward by applying a displacement of their load out of their support base.

In one embodiment of the present invention, a method is provided for detecting the subject's position in order to simulate a virtual environment in which gravity is manipulated (e.g., on the Moon or in water, e.g., in a swimming pool).

According to a further aspect of the present invention, a computer program is provided comprising instructions such that, when the program is executed by a computer, the computer performs one of the methods described above.

In the present invention, it should be understood that said methods of determining a subject's position are carried out for non-therapeutic, but playful and entertainment-related methods, such as, for example, in the case of a subject using a Virtual Reality visor and/or immersed in a virtual environment wherein external physical parameters, such as gravity, can be manipulated. In this way, the unweighting can make the subject's interaction with the virtual world more realistic.

### BRIEF DESCRIPTION OF THE FIGURES

The present invention will be described with reference to the attached figures in which the same numbers and/or reference marks indicate the same and/or similar and/or corresponding parts of the system.

FIG. 1 schematically shows an unweighting system to reduce the gravity load of a subject, according to an embodiment of the present invention.

FIG. 2 schematically shows the operation of the mechanical movement system of an unweighting system to reduce a subject's gravity load, according to a form of realization of the present invention.

FIG. 3 schematically shows an algorithm for controlling the subject's unweighting by means of a PID controller, according to a form of embodiment of the present invention.

FIG. 4 schematically shows an unweighting system equipped with a camera and a plurality of sensors to detect the subject's location, according to another form of realization of the present invention.

FIGS. 5A and 5B schematically show an algorithm for capturing the position of the body joints of a subject through a camera, according to a form of realization of the present invention.

FIG. 6 schematically shows an unweighting system to reduce the gravity load of a subject, servo-assisted on the three axes, according to another form of realization of the present invention.

### DETAILED DESCRIPTION

In the following, the present invention is described by referring to particular embodiments, as illustrated in the attached figures. However, the present invention is not limited to the particular embodiments described in the following detailed description and represented in the figures, but rather the described embodiments exemplify the various aspects of the present invention, the scope of which is defined by the claims. Further modifications and variations of the present invention will appear clear to the person skilled in the art.

In this disclosure, the unweighting systems and their operation will be described with respect to the Cartesian reference systems shown in the Figures, where the Z axis is oriented according to the direction parallel to the force of gravity.

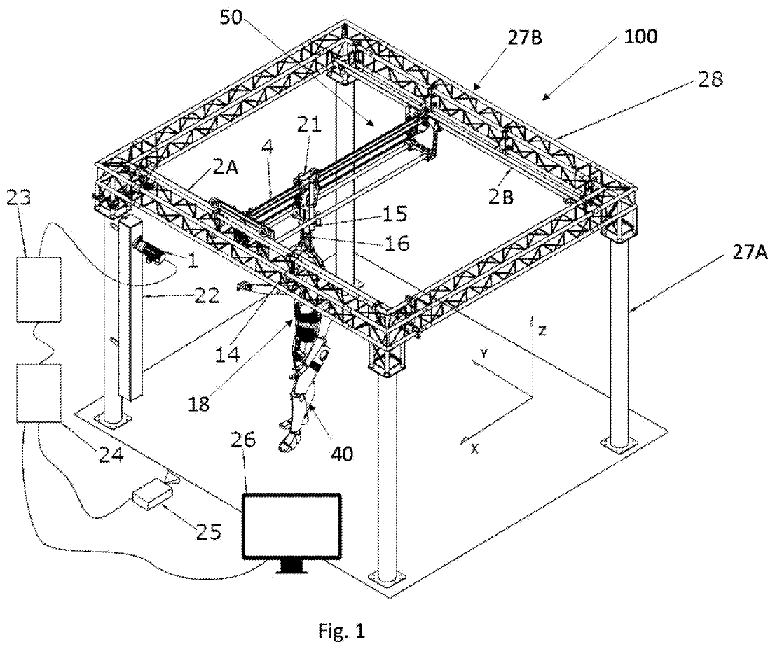

FIG. 1 schematically shows an assisted unweighting system 100 along the Z axis (unweighting system with one active axis), which can reduce the gravity load of the subject 40 due to the force weight, according to an embodiment of the present invention. For example, the unweighting system 100 can be used in the medical field or in athletic rehabilitation.

The unweighting system 100 includes a mechanical part and an electronic part.

The mechanical part includes a support structure 28, a motor 1 and a system of movement of the subject 50. The support structure 28 includes an upright system, specifically four 27A columns and four 27B beams.

For example, the motor 1 can be a servomotor. As shown in FIG. 1, the motor 1 is placed on a column 27A of the support system 28. In this way, the weight of the motor 1 is distributed to the ground directly through such column 27A and does not affect the subject 40 who uses the machine. In this way, the movement of the subject 40 is facilitated and not hindered by the footprint of the unweighting structure 100 itself. According to an alternative embodiment (not shown), the unweighting system 100 can be equipped with a motor 1 placed on any other element of the support system 28 and/or movement system 50, and this system can be equipped with the camera 25.

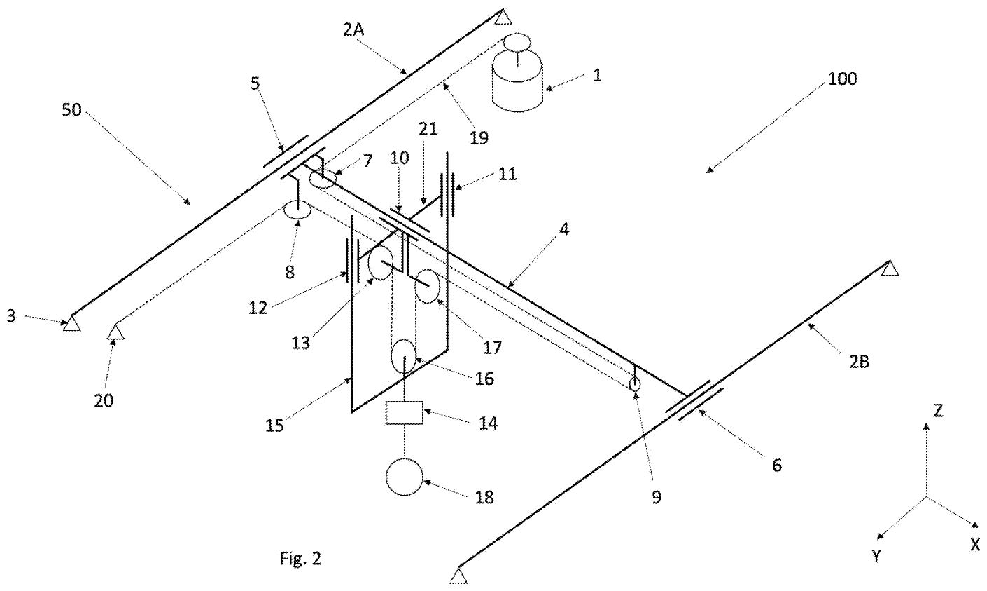

The mechanical movement system of the subject 50 is mounted on the support structure 28 and includes a plurality of rails 2A, 2B, 4, a cable 19, a sliding element 21 comprising a support element 18 for the subject, for example, a harness 18. The operation of the movement system of the subject 50 will be described in detail with reference to FIG. 2.

The electronic components of the unweighting system include an electronic control board 23, a computer 24, a camera 25 and a display and control terminal (or display) 26.

The unweighting system 100 according to the present invention makes it possible to reduce the gravity load of the subject 40 up to 80% of its total weight. The percentage of unweighting can be decided by the operator at the time of use and can be dynamically adjusted in real time thanks to the use of motor 1 controlled by the electronic board 23. Thanks to the unweighting system of the present invention, the subject 40 may carry out movements in the three-dimensional space below the unweighting system, for example several centimeters below the unweighting system.

The motor 1 is controlled by the electronic board 23, which acquires information from different sensors, processes them and returns to the motor 1 an indication of the driving torque and the speed to be achieved in order to obtain a cable 19 tension and cable speed in accordance with the set parameters. For example, this control may occur 100 times per second, both during the transient phases and during the static phases.

The operator can control the system settings through the graphical display interface 26 and can change the behavior of the system itself in real time.

System settings are contained in the electronic board 23. The computer 24 communicates with the electronic board 23 to read the variables that define the operation of the system, view them via the display 26 and send the settings to the electronic board 23 selected by the operator.

The computer 24 then communicates with the camera 25, acquires its raw information, processes and sends the processed information to the electronic board 23.

As described below, the electronic board 23 uses mathematical models to adjust the unweighting force and simulate various use conditions, for instance to simulate different conditions of virtual reality.

FIG. 2 schematically shows the operation of the movement system of the subject 50 of the unweighting system 100.

The movement system 50 includes the motor 1, two parallel rails 2A, 2B that extend along the Y axis, four supports 3 that are attached to the support structure 28 (not shown to simplify the scheme).

An additional rail 4 extends between the two rails 2A, 2B along the X axis. The sliding rail 4 is supported by the two sliding supports 5 and 6 that allow the rail 4 to move along the Y axis with reduced friction.

At the ends of the sliding rail 4, on one side, the pulleys 7 and 8 are attached, which are oriented so that the axis of rotation is parallel to the Z-axis and, on the other side, the pulley 9 which is oriented so that the axis of rotation is parallel to the Y-axis.

A sliding element 21 is mounted on the sliding rail; it is able to slide along the X-axis without rotating on the rail 4 by means of the sliding support 10. The sliding element 21 includes, in turn, sliding supporting components 11 and 12, pulleys 13 and 17, and the rigid “U-shaped” body 15. Pulleys 13 and 17 are oriented with the axis of rotation parallel to the Y axis and are able to rotate freely.

Preferably, the rigid body 15 is connected to the rest of the sliding element 21 by means of the sliding supporting components 11 and 12; alternatively, it can be connected through telescopic supporting components. In this way, the rigid “U”-shaped body 15 can slide freely along the Z axis without being able to rotate. The rigid body 15 is also connected to the pulley 16, which is free to rotate around an axis parallel to the Y axis. Integral with the body 15, a load cell 14 is formed, connected to the other end to the users harness 18. The load cell 14 is independent in rotation on the Z axis.

A cable 19 slides through all the pulleys. The cable 19 is attached to the support structure 28, at one end, through a fastener 20 and, at the other end, the cable 19 is wound on the winch of motor 1.

The motion system 50 allows vertical forces to be applied on the user by means of the motor 1, which, by winding the cable 19, decreases its length. This decrease in the length of the cable 19 is reflected on the sheave 16 and thus on the rigid body 15, which, by compensating for the dimensional differences of the cable 19, sides upward through the sliding supporting components 11 and 12, thus applying a lifting force to the harness 18 and, accordingly, to the subject. The components of unweighting system 100, with the exception of rigid body 15, do not move, as the cable 19 slides through the pulleys connected to the relevant bodies without imparting no force to these except that resulting from the rolling friction of the pulleys on the supports.

Once it has been partially relieved of its weight, the subject can move freely below the support structure 28, exploring the space in the XY plane. For being able to move in the XY plane, the subject must “carry” and make the sliding element 21 move as well. The forces in the XY plane, that are transmitted from the subject to the movement system 50, cause the cable 19 to slide on all the pulleys in the system, but since these forces do not cause a change in the length of the cable 19, they create no competing force to the tension of the latter.

For example, when the user moves along the X-axis, the sliding element 21 “follows” it and moves relative to the sliding rail 4 along the X axis. The cable 19, if the forces acting on it are balanced, remains stationary with respect to the rail 4, but the sliding element 21 can slide by means of pulleys 13, 16 and 17, which release the sliding element 21 from the cable 19 along the X axis, and by means of the sliding support 10, which releases the sliding element 21 from the sliding rail 4 along the X axis.

Similarly, translation along the Y axis can occur. In this case, all the pulleys 7, 8, 9, 13, 16 and 17 and the sliding supports 5 and 6 are involved to allow the movement of the movement system 15 as a result of the movement of the subject.

The movement system 50, in view of the system of pulleys 7, 8, 9, 13, 16 and 17, is advantageously designed so that the movement of the cable 19 is independent from the movement of the sliding element 21 along the third X axis and from the movement of the third rail 4 along the second Y axis. In fact, once the length of the cable 19 has been fixed following the action of the motor 1, the tension of the cable 19 on the siding element 21 is not affected by the displacement of the same in the XY plane, for example as a result of the movement of the rail 4 along the Y axis or as a result of the movement of the sliding element 21 by means of the sliding support 10 along the X axis. Similarly, the tension of the cable 19 on the sliding element 21 does not interfere with the displacement of the same in the XY plane, for example as a result of the movement of the rail 4 along the Y axis, or as a result of the movement of the sliding element 21 by the sliding support 10 along the X axis. This is possible due to the fact that the length and the tension of cable 19 are determined by the action of the motor 1, and then the cable 19 can slide freely on the system of pulleys 7, 8, 9, 13, 16, and 17, while the subject 40 performs the movements in the XY plane, hence moving the sliding element 21.

The rigid “U”-shaped body 15, due to its rigidity, allows optimal transmission of movements (and forces) to the sliding bodies 21 and 4, thus allowing the movement of the system (and the transmission of forces in the XY plane) in accordance with the subject's movements. Without this rigid body, the cable 19 would transmit motion inefficiently and only through its tension. In addition, considering that the friction of the sliding supporting components is not negligible, it is necessary that the body 15 is rigid in order for the subject to transmit sufficient force to overcome this friction.

The harness 18 and the harness support are independent in rotation along the Z axis to allow the subject to rotate around this axis while exploring the XY plane. The load cell 14 detects the tension on the harness and sends it to the control electronics, which through a PID control modifies the motor torque in real time.

The movement system 50 according to the present invention is capable of being translated passively in the XY plane (i.e., without the help of additional servomotors along the X and Y axes), even if only as a result of small forces exerted by the subject, for example, forces less than 1 N.

For example, the components of the movement system 50 can be made in high-performance and ultralight composite materials. Preferably, the sliding element 21 and the rigid body 15 are made of carbon fibers. Preferably, the support system 28 (27A columns and 27B beams) is made of steel.

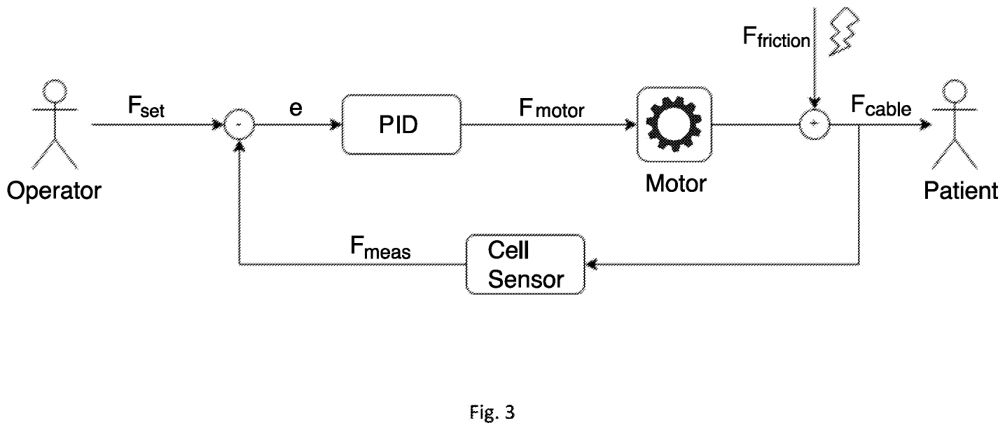

FIG. 3 schematically shows an algorithm for controlling the unweighting of a subject 40 by means of a load cell, according to an embodiment of the present invention.

In the unweighting system 100, the weight of the subject is reduced through a control in speed with torque limit on the motor 1. However, during the transient moments of control of the cable length 19, due to the friction and inertia of the system, the unweighting effective force F_{unweighting} applied by the motor 1 is different (e.g., lower) from the set force Fₛₑₜ in the motor 1. The unweighting system 100 according to the present invention includes a control system that can minimize the deviation between the force set Fₛₑₜ and the effective force F_{unweighting} applied by the motor 1. The force control system F_{M} is based on the use of one or more load cells 14 and a PID controller (Proportional Integrative Derivatives).

The load cell 14 then measures the force Fₘₑₐₛ applied at a given time t on the harness 18 and the force Fₘₑₐₛ is used as the feedback element of the PID controller, according to the following formula:

$${F}_{M} = {F}_{set} + {k}_{p} \cdot e + {k}_{i} \cdot \sum e \cdot dt + {k}_{d} \cdot \frac{e - {e}_{last}}{dt} ,$$

$$with e = {F}_{set} - {F}_{mis}$$

$$where {F}_{M} : force exerted by motor 1 on support element 18 in order to reduce the weight of the subject 40 ;$$

$${k}_{p} : proportionality coefficient of the PID controller ;$$

$$e : difference between the force value set {F}_{set} and the force value measured {F}_{meas} by the load 14 , at current sampling t .$$

$${k}_{i} : PID controller integration coefficient .$$

$${k}_{d} : PID controller derivation coefficient .$$

$${e}_{last} : error e at previous sampling {t}_{- 1} .$$

$$dt : system sampling time .$$

In other words, the PID controller calculates the deviation e=Fₛₑₜ−Fₘₑₐₛ between the set unweighting force Fₛₑₜ and that measured Fₘᵢₛ by load cell 14 and use this data to calculate the terms proportional (kₚ·e), integrative (kᵢ·Σe·dt) and derivative

$$( {k}_{d} \cdot \frac{e - {e}_{last}}{dt} )$$

of the correction factor of the effective force F_{M} to be applied by motor 1 so as to minimize or cancel the deviation e.

Preferably, this check is performed 100 times per second while using the unweighting system 100, either during transient phases in which the length of the cable 19 is varied, or during static phases.

The control system just described is also supplemented with the following functions of safety to prevent the subject 40 from falling:
checking the consistency of the weight applied to the load cell 14 and the set weight to be unweighted;
checking the maximum possible cable travel 19, by using an encoder directly connected to the shaft of motor 1 and contained in the motor itself;
checking the speed of motor 1, by using the encoder derivative. This datum is provided directly by the motor drive. In the case of assisted unweighting system on multiple axes, which will be described later, the speed of all motors can be controlled.

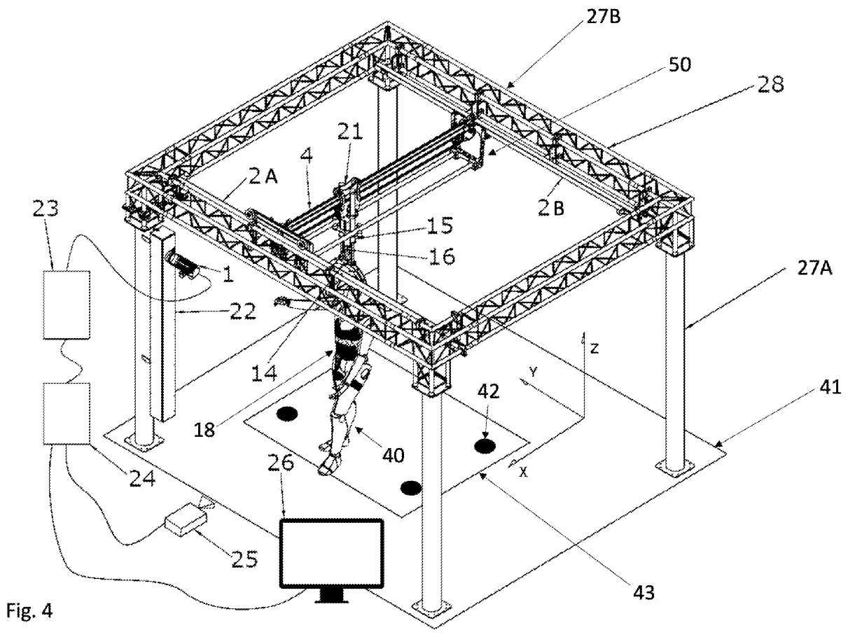

As shown schematically in FIG. 4, the unweighting system 100 is used in combination with a camera 25, for example, an RGB, Depth or RGB-D camera.

The advantage of the RGB camera is that it reduces system production costs and allows detection of the subject's joints in two-dimensional space.

The advantage of the Depth camera is that it allows detection of the subject's joints in three-dimensional space.

The advantage of the RGBD camera is that it allows detection of the subject's joints in three-dimensional space with greater accuracy. Thanks to the fact that the RGB-D camera allows the user's location to be detected accurately, precisely and comprehensively, the unweighting system 100 equipped with the RGB-D camera is able to interact with the user in a manner predictable and safe.

In an RGB-D camera, the RGB part relates to the ability to detect images in the visible frequency range, in particular the green, red and blue frequencies, in a way similar to the human eye. The RGB then produces an image of an object in two dimensions.

To obtain the third dimension, there are different technologies and the data produced correspond to a “point cloud” in which each point of the object is represented in all three dimensions of the space.

According to a preferred configuration of the present invention, an RGB-D camera is used with “time-of-flight” technology, for example, a Kinect Azure camera. The Time-of-flight camera includes a laser that emits a beam of light in the infrared spectrum and an infrared camera sensitive only to these frequencies. The beam of light, when it encounters an object, is refracted in all directions, including that of the infrared camera. By analyzing the time it takes for the beam to leave the laser, hitting an object and return to the room, the distance of this object can be calculated.

According to a further preferred configuration of the present invention, a RGB-D stereoscopic camera, for example, an Intel Realsense camera. The camera stereoscopic contains two RGB or infrared cameras placed at a known distance. Each camera captures an image in two dimensions and in each of them the common objects seen by both cameras are found. Knowing the distance between the two cameras it is possible to reconstruct the exact position in three dimensions of each object.

The passive version of the stereoscopic camera has the disadvantage that, if there are no objects in the scene, it is not possible to find elements that are seen by both cameras.

To overcome this disadvantage, in the active version of the stereoscopic camera is mounted a projector that generates dots with random positions in space, in the infrared spectrum so that they are not visible to the human eye. In this way, the scene view from both cameras is enriched with information, thus being able to reconstruct the third depth dimension.

A classical camera acquires information about 30 times per second and contains about 200000 points in three-dimensional space, thanks to which it is possible to reconstruct the volume of the objects in the scene. This is also why they are called volumetric cameras.

According to a further preferred configuration of the present invention, a skeletal tracking technology, or “skeletal tracking” technology, is used to derive the three-dimensional representation of a person present within the scene, based on the data acquired from the RGB-D camera.

There are skeletal tracking algorithms that, from the volumetric profile of a person, are able to recognize the position of the subject joints. These algorithms are divided mainly into two categories: the old generation classical algorithms that are based on the Graph Theory and next-generation ones that are based on Machine Learning (Random Forest and Neural Network).

Next-generation algorithms are advantageous because they are more stable and versatile than those of the older generation. In addition, the new generation algorithms can be improved by increasing the image dataset, without changing the source code.

For example, according to the present invention, skeletal tracking technology can exploit the data acquired by an RGB-D camera and can be used to detect the following user's joints: pelvis center, mass center, shoulder center, left hip, right hip, left knee, right knee, left ankle, right ankle, left foot, right foot, left shoulder, right shoulder, left elbow, right elbow, left wrist, right wrist, hand left, right hand, neck, mouth, nose, left ear and/or right ear.

Knowing the position in three-dimensional space of these body joints is possible then to precisely and stably define all positions taken by the user. In addition, it is possible to calculate all body joint angles, which are useful in determining mobility capacity joint of the analyzed subject. These data are acquired 30 times per second, thus making it possible to track movements in space and time smoothly and continuously.

According to a preferred configuration of the present invention, a technology of markerless skeletal tracking is used. Alternatively, a technology of marker-based skeletal tracking is used.

Markerless technology allows images of subjects to be captured based on data from a camera, without the use of markers or sensors attached to the subjects themselves. In particular, markerless skeletal tracking technology allows to derive the 3D positions of the joints of a subject immersed in an acquisition area, without the use of markers, nor of sensors attached to the subject itself. In contrast, marker technology based allows the acquisition of images of subjects to which markers or sensors have been applied.

Markerless technology has several advantages. First, since it is not necessary to apply markers, so image acquisition times are reduced.

In addition, markerless technology cameras allow images of subjects to be captured in more economically and efficiently than marker-based technology cameras, because highly trained personnel are not required to apply the markers.

Any errors in marker placement in turn induce errors in detection of the positions of the user's body parts marked by the markers.

It should then be considered that, during image acquisition, markers can move or detach from the position in which they were originally fixed and that any deviations of the markers from their original positions increase the detection error of the positions of the user's body parts marked by the markers.

In addition, the analysis of data acquired on the basis of markers is often time-consuming and complex, requiring the presence of qualified technical personnel. In contrast, markerless systems provide data in real time and do not require the presence of trained personnel to analyze the acquired data.

Finally, markerless technology systems are advantageous because they enable the acquisition and analyze the data more precisely and accurately. In fact, different data acquisition centers can train personnel to apply markers differently, so usually the error inter-center (i.e., the error calculated from data acquired from different centers, while applying the same procedure) is higher than the intra-center error (i.e., the error calculated from data acquired from the same acquisition center). There are also different acquisition protocols of data that define the different types of markers and consequently calculate the joint centers in different way and in different positions, lowering the repeatability of acquisitions. In contrast, in the markerless systems, repeatability of acquisitions is ensured by using the same algorithm of Skeletal Tracking that always places markers in the same spots. Preferably, the camera 25 is placed at the height of about 1 m from the base 41 of the unweighting system 100 and is positioned to frame the center of the subject's operational area in the unweighting system 100.

The camera 25 allows detection of the subject 40 under consideration and its position in space within which it has freedom to move. Specifically, through camera 25, it is possible to accurately identify the location of all body joints as well as their orientation.

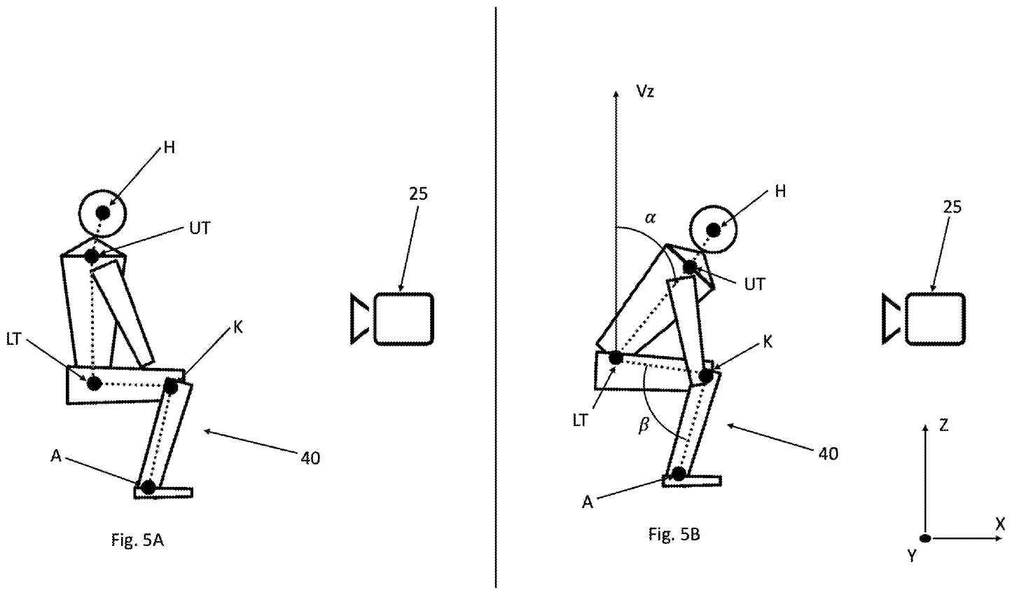

FIG. 5A shows schematically the acquisition of the position of body joints H, UT, LT, K, A of the subject 40 through the camera 25. The acquisition of information is performed by computer 24, which processes this information by calculating the flexion-extension angle of the trunk and femur of subject 40 with respect to the Vz axis, according to the following formula:

$${Trunk}_{F E} = α = {tan}^{- 1} ( \frac{{P}_{x}^{U T} - {P}_{x}^{L T}}{{P}_{z}^{U T} - {P}_{z}^{L T}} ) \cdot \frac{180}{π} [ ° ]$$

$$Where :$$

$${Trunk}_{F E} = flexion - extension angle of the subject ’ \text{} s trunk 40 with respect to the Vz axis , in the XZ plane .$$

$${P}_{x}^{U T} = position of the upper trunk joint , on the X axis .$$

$${P}_{x}^{L T} = position of the lower trunk joint , on the X axis .$$

$${P}_{z}^{U T} = position of the upper trunk joint , on the Z axis .$$

$${P}_{z}^{L T} = position of the lower trunk joint , on the Z axis .$$

$$Femur = β = {tan}^{- 1} ( \frac{{P}_{x}^{L T} - {P}_{x}^{K}}{{P}_{z}^{L T} - {P}_{z}^{K}} ) \cdot \frac{180}{π} [ ° ]$$

$$Where :$$

$$Femur = flexion - extension angle of the subject ’ \text{} s femur 40 with respect to the Vz axis , on the XZ plane .$$

$${P}_{x}^{LT} = position of the lower trunk joint , on the X axis .$$

$${P}_{x}^{K} = position of the knee joint , on the X axis .$$

$${P}_{x}^{K} = position of the lower trunk joint , on the Z axis .$$

$${P}_{z}^{K} = position of the knee joint , on the Z axis .$$

Femur angle is calculated for both the right leg β_{R} and the left leg β_{L} and is mediate the two values to obtain a single femur angle β through the formula:

$$β = \frac{{β}_{R} + {β}_{L}}{2}$$

In FIG. 5A, subject 40 is sitting with an upright back, consequently the flexion-extension angle of the trunk a is close to 0°, while the femur angle is close to 90°. When the subject 40 flexes the trunk forward (as shown schematically in FIG. 5B), the angle α increases and when it exceeds a threshold set by the operator, such as 30°, the subject 40 is lifted through motor drive 1 (not shown) by harness 18 (not shown).

During lifting, the angles α and β decrease. Such lifting ends when both angles α and β fall below a certain threshold, for example, a threshold of 10° for α and a threshold by 20° for β.

Through this mode, it is possible to automate the process of transferring the subject 40 from a sitting position to a standing position. Camera 25 thus replaces the eye of the operator, who would otherwise have had to manually operate the lifting of the subject 40.

In addition, this method increases the safety factor because lifting occurs only when the subject 40, leaning forward, transfers its load from the seat to its legs, limiting the effect of feeling like he is hanging from a cable lifting him dead weight.

The unweighting system 100 can also be equipped with a force and/or pressure sensor system 42, fixed on a platform 43, configured to detect the subject's position 40 according to the weight distribution measured on the basis 41 of the unweighting system 100.

For example, the force and/or pressure sensor system may include a stabilometric platform 43. The stabilometric platform 43 consists of four load cells, joined by a rigid plane. With the measurement of these four load cells, it is possible to measure the total load applied by the subject 40 and consequently, estimate its weight. In addition, it is possible to measure in real time the Center of Pressure (COP) of subject 40. When subject 40 is stationary, the rate at which COP varies over time is used to assess in real time the ability of balance of the subject 40. The higher the speed, the more unstable subject 40 is. By accordingly, the responsiveness of the unweighting system 100 is set according to this measure.

In addition, the COP verifies the correct position of the subject 40 measured by the camera 25. The operation of the stabilometric platform 43 is described in detail in the patent application WO2015118439 of the same applicant, the contents of which are incorporated herein in their entirety for reference.

The information gathered from the analysis of camera 25 and/or sensors 42, 43 is used to equip the unweighting system 100 with various additional functions that would not be available without the use of the same.

For example, due to the presence of camera 25 and/or sensors 42, 43, it is possible to identify the precise position of subject 40 in 3D space and therefore place correctly and automatically harness 18 along the Z axis. In assisted unweighting systems along the three axes, X, Y and Z (the unweighting systems with three active axes), is possible to automatic positions the harness also on the X and Y axes.

The presence of camera 25 and/or sensors 42, 43 also makes it possible to provide a potential fall of the subject and to intervene before the fall actually occurs, preventing it. In fact, thanks to camera analysis, it is possible to monitor the state of balance of the subject, making the system more responsive in precarious balance situations and assisting the work of the load cell.

This mode is of fundamental importance because it increases inherently the safety factor of the whole system. For example, if the camera detects continued states of precarious balance, the settings of the unweighting system 100 are changed, so that it is more responsive and allows less wide and less fast movements (e.g. lunges).

Another additional function related to the presence of camera 25 and/or sensors 42, 43 is the automatic adjustment of the unweighting force applied in horizontal transfer situations of the load. In fact, the camera is able to detect the bending angle of the subject's trunk 40 and, as a result, the system can adjust the lift so that it is only applied when really needed. In contrast, in known unweighting systems, lifting is implemented manually by the operator only after the person has completed the forward transfer of its weight.

In addition, throughout operation, camera 25 and/or sensors 42, 43 can perform movement analysis and provide information regarding its quality.

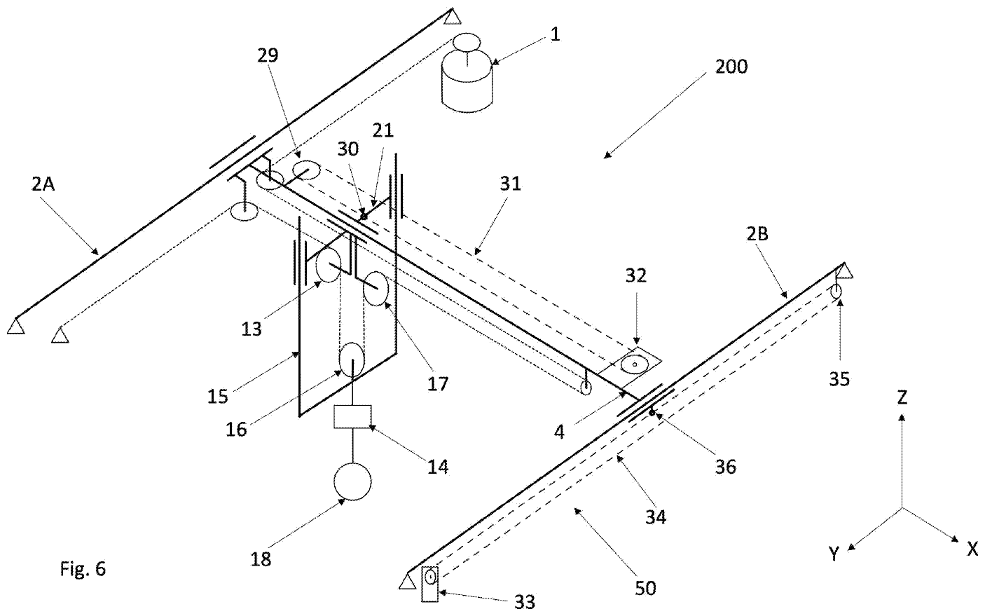

Finally, in the unweighting system with three active axes 200 (described below with reference to FIG. 6), the presence of the camera 25 and/or sensors 42, 43 allows the position of the subject 40 in case it is deviating from the optimal movement, based on the knowledge of the movement that is to be performed and by monitoring the subject's movement in real time. For example, if subject 40 is to perform a lunge and during that movement he maintains the trunk flexed laterally to the left, the unweighting system 200 corrects it by pulling toward right in order to keep it correctly in the center.

FIG. 6 shows schematically the operation of the movement system 50 for the unweighting system 200 with three active axes.

The unweighting system 200 with three active axes has the advantage of preventing the subject 40 from having to move the lifting motor over one's head, because such movement is performed by three motors 1, 32, 33.

Even in the case of the three active axes, having very light moving mechanical organs brings some great advantages. The motors that move the x- and y-axes will not require large powers, moreover, being low inertia and friction, it will be easier to control them.

The movement system 50 of the unweighting system with three active axes 200 includes the same movement system 50 structure of the unweighting system 100 one-axis active and also includes a first additional motor 32 and a second additional motor 33 and an additional pair of pulleys 29. For example, the first and second additional motors can be servomotors.

A first idler pulley 29 and the first motor 32 are attached to rail 4 by additional supports, both oriented with their rotation axes parallel. The first additional motor 32, through a toothed pulley that is part of its drive shaft, moves a first belt closed ring gear 31 that is returned by the first return pulley 29. The first belt toothed is attached at a point 30 to the sliding element 21 by means of a special bracket. Each time the first additional motor 32 makes one rotation or a fraction thereof, the first belt 31 moves and the sliding element 21 moves along the X axis in accordance with the direction of rotation of the first additional motor 32.

On one of the two fixed rails 2A, 2B, the second additional motor 33 and the second idler pulley 35 are fixed by means of supports, both oriented with their rotation axes parallel. The second additional motor 33 through a second pulley 35 forming part of its shaft motor moves a second ring 34 closed toothed belt that is returned by the second idler pulley 35. The second toothed belt 34 is attached at one point 36 to the rail 4 by means of an appropriate stand. Each time the second additional motor 33 makes a rotation or a fraction of it, the second toothed belt 34 moves and the rail 4 moves along the Y-axis in accordance with the direction of rotation of the motor 33. The remaining mechanical organs, behave exactly the same as in the one-axis active solution, and they are exactly the same. In this solution, rail 4 and sliding element 21 are moved directly by additional motors 32 and 33, rather than being moved directly by the subject's transversal forces, in accordance with the information computed by the control electronics 23 based on information from the load cell 14 and from camera 25.

The following is a brief presentation of the main modes of operation of the unweighting 100, 200, based on the adjustment of the applied unweighting force.

### 1. Isotonic Mode

In this mode, a force is applied such that when the subject 40 performs a movement, the force of unweighting always remains constant.

The force that is applied to harness 18 via motor 1 is calculated via the control system based on load cell 14 and described in connection with FIG. 3. Through the control system, we search for the working condition in which the following condition holds:

$${F}_{set} = {F}_{unweightin}$$

$$Where :$$

$${F}_{set} : force set at the input of the PID controller .$$

$${F}_{unweightin} : load relieving force set by the operator .$$

### 2. Elastic Mode

In this mode, the inextensible cable 19 behaves like an elastic cable. The force that is applied to harness 18 via motor 1 follows the following formula:

$${F}_{set} = {F}_{unweighting} + {k}_{e} \cdot Δ P$$

$$Where :$$

$${F}_{set} : force set at the input of the PID controller .$$

$${F}_{u n weighting} : load relieving force s et by the operator .$$

$${k}_{e} : elastic coeffiecient you want to impose on the inextensible cable . The higher it is , the greater the unweighting force applied to subject 40 , with equal elongation Δ P .$$

$$Δ P : elongation of the cable from the starting position {P}_{0} where the subject 40 is in upright position .$$

### 3. Isokinetic Mode

In this mode, an unweighting force is applied such that when the subject 40 performs a movement in the direction of gravity, the downward velocity remains constant.

As opposed to the weight of subject 40, which drags the harness 18 in the direction of the gravity vector, the following force is applied to element 18:

$${F}_{set} = {k}_{a} \cdot v$$

$$Where :$$

$${F}_{set} : force set at the input of the PID controller .$$

$${k}_{a} : coefficient of friction . This coefficient determines the descent speed of the element ( 18 ) ; the higher it is , the lower the rate of descent .$$

$$v = \frac{{P}_{t} - {P}_{t - 1}}{dt} : rate of descent of the element ( 18 ) . {P}_{t} - {P}_{t - 1} corresponds to the difference in location of element 18 in a time frame dt .$$

4. Model Simulating Gravity Other than Earth's Gravity

In this mode, it is possible to simulate gravity other than Earth's gravity. The force constant to be applied to element (18) is as follows:

$${F}_{set} = {m}_{u s e r} \cdot ( {a}_{earth} - {a}_{desired} )$$

$$Where :$$

$${F}_{set} : force set at the input of the PID controller in order to simulate the vertical movement of the subject 40 in a gravitational field different from Earth ’ s .$$

$${m}_{user} : mass in kg of subject 40 to be relieved .$$

$${a}_{eart} : Earth ’ s acceleration of about 9 , 807 m / {s}^{2} .$$

$${a}_{desired} : acceleration that you want to simulate . For example , to simulate movements made in the lunar gravitational field the desired acceleration corresponds to 1.62 m / {s}^{2} .$$

### 5. Model Simulating Water

In this mode, the condition in which the subject 40 is immersed in a tank is simulated of water. This mode of using the unweighting system 100, 200 requires the presence of a camera 25 to determine the position of the body joints of the subject 40.

The operator selects the desired water level, where that level is defined, for example, in percentage with respect to the height of the subject 40. Camera 25 then determines the amount of body volume of the subject 40 that would be immersed in water under the simulated conditions. The unweighting system 100, 200 finally simulates the corresponding buoyancy force, taking into also account for the contribution of friction given by fluid viscosity.

For example, the operator sets the water level height equal to 1 meter. The camera 25 provides the positions of all body joints of subject 40, so that it is possible to determine which parts of the body are placed below a height of 1 meter. The volume is then calculated of all body parts under 1 meter, through anthropometric tables known from the literature.

The total volume of the virtually submerged body parts is composed of the sum of the individual parts, according to the following formula:

$${V}_{tot} = {\sum }_{i = 0}^{N} {V}_{i}$$

$$Where :$$

$${V}_{tot} : total volume of body parts below the set water level ;$$

$$N = number of body parts below the set water level ;$$

$${V}_{i} : volume of each individual body part below the set water level .$$

$$In the mode , pure water is simulated , where 1 liter of pure water in the field Earth ’ s gravitational force weighs 1 kg . Knowing the total volume in liters of water displaced , the force of vertical thrust that is set at the input of the PID controller corresponds to :$$

$${F}_{set} = {V}_{tot} \cdot {a}_{earth}$$

$$Where :$$

$${F}_{set} : force set at the input of the PID controller in order to simulate the vertical thrust of the subject 40 virtually submerged in water ;$$

$${V}_{tot} : total volume of body parts below the water level .$$

$${a}_{earth} : Earth ’ s acceleration of about 9 , 807 m / {s}^{2} .$$

These work modes take advantage of one or more motors 1 controlled in real time and provide the therapist a range of tools that he or she can use to perform more specific training based on to the person to be rehabilitated and, consequently, the type of treatment to be performed.

Although the present invention has been described with reference to the forms of embodiment described above, it is clear to the branch expert that several modifications can be made, variations and improvements of the present invention in light of the teaching described above and within the scope of the attached claims, without departing from the object and scope of protection of the invention.

For example, although the use of camera 25 and force sensors and/or pressure in combination with the unweighting system 100 at an active axis, it should be understood that the camera 25 and force and/or pressure sensors can also be used in combination with the unweighting system 200 with three active axes.

According to a preferred embodiment, an unweighting system is provided to reduce the gravity load of a subject due to the weight acting along a first axis, said unweighting system comprising a support structure, a motor and a movement system of the subject mounted on the support structure, wherein the movement system includes the following elements:
a first rail and a second rail parallel to a second axis;
a third rail parallel to a third axis perpendicular to the second axis, wherein the third rail extends between the first rail and the second rail and is configured to slide along the first and second rails and to move along the second axis;
a sliding element configured to slide along the third rail in the direction of the third axis;
a cable associated with the slicing element and driven by the motor to move the subject along the first axis;
a support element for the subject, associated with the cable;

wherein the first axis, the second axis and the third axis form a Cartesian coordinate system, and

wherein the motor is fixed to the support structure so that at least a portion of the weight of the motor, preferably all of the weight of the motor, is distributed to the ground directly through the support structure and not (indirectly) through the movement system, and the cable extends between the motor and a fixed element integral with the support structure, and the length of the cable between the motor and the fixed element is variable as a result of the action of the motor. Said unweighting system also includes a camera configured to detect a position of the subject in space.

Finally, those areas that are considered to be known by experts in the field have not been described to avoid unnecessarily overshadowing the described invention.

Accordingly, the invention is not limited to the forms of embodiment described above but is only limited by the scope of protection of the attached claims.

### LIST OF REFERENCE NUMBERS

1: Motor
2A, 2B: Fixed Rails
3: Support between fixed rail and support structure
4: Mobile Rail
5, 6: Sliding supports of the movable rail
7, 8: Pulleys connected to the moving rail by rotation around the Z axis
9: Pulley connected to the moving rail for rotation around the Y axis
10, 11, 12: Sliding supporting components of the sliding element
13: Pulley connected to the sliding element for rotation around the Y axis
14: Load cell
15: U-shaped rigid body
16: Pulley connected to the sliding element for rotation around the Y axis
17: Pulley connected to the sliding element for rotation around the Y axis
18: Harness
19: Cable
20: Fixed element integral with the support structure
21: Sliding element on the moving rail along the X axis
22: Motor transmissions
23: Electronic control board
24: Computers
25: Camera
26: Display and control terminal
27A, 27B: Support structure upright
28: Support structure
29: First idler pulley
30: Fastening point of the first toothed belt
31: First toothed belt
32: First additional motor
33: Second additional motor
34: Second toothed belt
35: Second idler pulley
36: Attachment point of the second toothed belt
40: Subject
41: Base of the support structure
42: Force and/or pressure sensors
43: Stabilometric platform
50: Subject movement system
100: One-axis servo-assisted unweighting system
200: Servo-assisted unweighting system on the three axes

1. An unweighting system for reducing the gravity load of a subject due to the weight acting along a first axis, said unweighting system comprising: a support structure; a motor; and a movement system of said subject mounted on said support structure,
wherein said movement system includes the following elements:
a first rail and a second rail parallel to a second axis and integral with said support structure;
a third rail parallel to a third axis perpendicular to said second axis, wherein said third rail extends between said first rail and said second rail and is configured to slide along said first and second rails so as to move along said second axis;
a sliding element configured to slide along said third rail in the direction of said third axis;
a cable associated with said sliding element and driven by said motor to reduce the gravity load of said subject;
a support element for said subject, associated with said cable;
wherein said first axis, said second axis and said third axis form a Cartesian coordinate system,
wherein said unweighting system further comprises a camera, for example a camera of the RGB, RGB-Depth or Depth type, and an electronic board configured to locate the position of a plurality of articular joints of said subject in space by means of markerless technology on the basis of the data acquired by said camera; and
wherein said support structure is placed on a base in contact with the ground and said unweighting system further comprises a plurality of sensors, for example force and/or pressure sensors, for determining a weight applied by said subject on said base.

2. An unweighting system with three active axes comprising:
an unweighting system according to claim 1;
a first additional motor; and
a second additional motor;
wherein said first additional motor is configured to move said sliding element along said third rail and said second additional motor is configured to move said third rail along said first and said second rails.

3. (canceled)

4. (canceled)

5. The unweighting system according to claim 1, wherein said plurality of sensors is placed in a stabilometric platform.

6. A method for determining the position of a subject with respect to the unweighting system according to claim 1, for example for virtual reality simulations, said method comprising the following step:
a. detecting a position of a plurality of articular joints of said subject, by means of said camera (25) and by means of a markerless technology algorithm.

7. The method according to claim 6, further comprising the following steps:
b. detecting a distribution of said weight on said base by means of said plurality of sensors;
c. transmitting the data collected by said plurality of sensors related to said distribution to an electronic control board;
d. processing said data so as to obtain said position of said subject with respect to said unweighting system.

8. The method according to claim 6, further comprising the step of placing said support element in correspondence with said subject along said first axis by means of said motor, after determining the position of said subject.

9. The method according to claim 6, wherein said unweighting system comprises a first additional motor configured to move said sliding element along said third rail and a second additional motor configured to move said third rail along said pair of rails,
wherein said method further comprises the step of positioning said support element in correspondence with said subject along said second axis by means of said first additional motor and said third axis by means of said second additional motor, after determining the position of said subject.

10. The method according to claim 6 further comprising the following steps:
e. comparing said position with a reference position and determining the deviation from said reference position;
f. assigning a quality parameter, for example a positive or negative parameter, to said subject according to said deviation.

11. The method according to claim 6, further comprising the following steps:
e. comparing said position with an equilibrium reference position of said subject and determining the deviation from said reference position;
g. if said deviation exceeds a predefined threshold value, sending a signal to an electronic board via a computer connected to said camera, wherein said signal includes operating instructions for said unweighting system.

12. The method according to claim 11, wherein said operating instructions of said step g) comprise varying the length of said cable by means of said motor, so as to lift said subject along said first axis and counteract the fall of said subject.

13. The method according to claim 11, wherein said operating instructions of said step g) comprise determining the position of said subject a plurality of times at predefined time intervals, so as to determine a sequence of positions over time.

14. The method according to claim 11, wherein said unweighting system comprises a first additional motor configured to move said sliding element along said third rail and a second additional motor configured to move said third rail along said pair of rails, and
wherein said operating instructions of said step g) include adjusting the position of said support element along said first axis, said second axis and said third axis by means of said motor, said first additional motor and said second additional motor, respectively, so as to reduce said deviation.

15. A method for simulating a condition in which a subject is immersed in water comprising the following steps:
a. detecting a position of predefined elements of said subject according to the method of claim 6;
b. setting a predefined water level with respect to a base of said unweighting system on which said subject is located and determining which of said predefined elements of said subject are below said level;
c. calculating the body volume of said subject placed below said predefined water level;
d. calculating the vertical buoyant force exerted by the water as a function of said body volume placed below said predefined water level;
e. setting an unweighting force equal to said vertical buoyant force by means of said unweighting system.

16. A method for simulating a condition in which a subject is subjected to a predefined gravitational force comprising the following steps:
detecting a position of predefined elements of said subject according to the method of claim 6;
setting an unweighting force proportional to a predefined gravitational acceleration, for example a terrestrial or lunar gravitational acceleration.

17. A method for simulating a condition in which a subject is subjected to a predefined unweighting force comprising the following steps:
detecting a position of predefined elements of said subject according to the method of claim 6;
setting a predefined unweighting force, for example an unweighting force constant over time, having an elastic trend, and/or directly proportional to the descent speed of said support element.

18. A computer program comprising instructions such that, when the program is executed by a computer, the computer performs the steps of any one of the methods of claim 6.

19. The unweighting system according to claim 1, wherein the support structure comprises four columns and four beams, and said motor is fixed to said support structure, preferably to one of said columns, so that at least part of the weight of said motor, preferably the entire weight of said motor, is distributed to the ground directly by means of said support structure and not by means of said movement system, and
wherein said cable extends between said motor and a fixed element integral to said support structure, and the length of said cable between said motor and said fixed element is variable as a result of the action of said motor.

20. The unweighting system according to claim 19, wherein said cable is threaded along a set of pulleys configured to transfer the motion of said cable, driven by said motor, from a direction parallel to said second axis and/or said third axis to a direction parallel to said first axis, so as to reduce the gravity load of said subject.

21. The unweighting system according to claim 20, wherein said motion of said cable is independent from a motion of said sliding element along said third axis and a motion of said third rail along said second axis.

22. The unweighting system according to claim 20, wherein said set of pulleys comprises, along the running direction of said cable driven by said motor, the following elements:
A first pulley having an axis of rotation parallel to said first axis;
A second pulley having an axis of rotation parallel to said second axis;
A triplet of pulleys, each having an axis of rotation parallel to said second axis;
A sixth pulley having an axis of rotation parallel to said first axis.

23. The unweighting system according to claim 1, wherein said sliding element comprises a rigid U-shaped body configured to move along said first axis because of a variation in the length of said cable, preferably by sliding along a pair of sliding supporting components associated with said sliding element or by means of a pair of telescopic supporting components.
